(19) United States
(12) Patent Application Publication
(10) Pub. No.: US 2026/0089393 A1
(43) Pub. Date: Mar. 26, 2026

(54) IMAGING APPARATUS

(71) Applicant: Panasonic Intellectual Property Management Co., Ltd., Osaka (JP)

(72) Inventor: Yasuhiro SHINGU, Osaka (JP)

(73) Assignee: Panasonic Intellectual Property Management Co., Ltd., Osaka (JP)

(21) Appl. No.: 19/328,119

(22) Filed: Sep. 13, 2025

(30) Foreign Application Priority Data
Sep. 20, 2024 (JP) 2024-163599

(51) Int. Cl. H04N 23/68; H04N 23/55; H04N 23/63; H04N 23/663; H04N 23/667

(52) U.S. Cl. CPC H04N 23/687; H04N 23/55; H04N 23/632; H04N 23/663; H04N 23/667

(57) ABSTRACT

An imaging apparatus includes: an image sensor that captures a subject image via an optical system; an image stabilizer that performs image stabilization responding to shake of the imaging apparatus; a display that displays an image captured by the image sensor; a user interface that receives a user operation; and a controller that controls the image stabilizer, based on the user operation in the user interface, wherein the controller causes the display to display a setting screen for setting stabilization power indicating a degree to perform the image stabilization, and receives the user operation on the setting screen in the user interface, to set the stabilization power in accordance with the user operation.

### TECHNICAL FIELD

The present disclosure relates to an imaging apparatus having a image stabilization function.

### BACKGROUND ART

JP 2006-074402 A discloses an imaging apparatus for creating a state in which a range where camera shake can be strongly corrected is wide, even when a correctable region is constant at the time of a user selecting the strength of correction in image stabilization. The imaging apparatus includes camera shake detection means for detecting camera shake vibration and a correction amount calculator. The correction amount calculator calculates a correction amount in image stabilization processing for camera shake amount data detected by the camera shake detection means, in accordance with image stabilization type information indicating the strength of the image stabilization processing, distance relationship information between the current correction position and the end of the correctable range, and stabilization powerening flag information.

JP H07-075001 A discloses a video camera intended to obtain a more natural motion image of a moving subject while performing image stabilization in accordance with a motion of a camera casing or the like. The video camera sets a correction amount upper limit and a correction ratio on the basis of an image shake amount, a zoom magnification, and a switch operation amount. In an auto mode, the correction ratio and the correction amount upper limit can be changed in conjunction with the zoom magnification during shooting, and in a manual mode, the correction ratio can be changed by operating a variable lever or a dial. The correction amount upper limit/correction ratio is displayed on the lower side of a viewfinder screen.

### SUMMARY

The present disclosure provides an imaging apparatus capable of facilitating achieving image stabilization according to a user preference.

In the present disclosure, an imaging apparatus includes: an image sensor that captures a subject image via an optical system; an image stabilizer that performs image stabilization responding to shake of the imaging apparatus; a display that displays an image captured by the image sensor; a user interface that receives a user operation; and a controller that controls the image stabilizer, based on the user operation in the user interface, wherein the controller causes the display to display a setting screen for setting stabilization power indicating a degree to perform the image stabilization, and receives the user operation on the setting screen in the user interface, to set the stabilization power in accordance with the user operation.

According to the imaging apparatus of the present disclosure, achieving image stabilization according to the user preference can be facilitated.

### BRIEF DESCRIPTION OF DRAWINGS

FIG. 1 is a perspective view of a digital camera according to a first embodiment of the present disclosure;

FIG. 2 is a block diagram showing a configuration of the digital camera according to the first embodiment;

FIG. 3 is a block diagram showing a configuration of an in-body image stabilizer (IBIS) processor in a digital camera according to the first embodiment;

FIG. 4 is a block diagram showing a configuration of an optical image stabilizer (OIS) processor in the digital camera according to the first embodiment;

FIG. 5 is a flowchart illustrating the operation of the digital camera according to a first embodiment;

FIG. 6 is a diagram showing a display example of a setting menu for image stabilization in the digital camera;

FIGS. 7A and 7B are diagrams showing a display example of a live view screen in the digital camera;

FIG. 8 is a flowchart illustrating a stabilization power setting process in the digital camera;

FIG. 9 is a diagram showing a display example of a stabilization power setting screen in the digital camera according to the first embodiment;

FIG. 10 is a diagram showing a display example of a test display screen in the digital camera;

FIG. 11 is a diagram showing a display example of a stabilization power setting screen when a horizontal lock function of the digital camera is enabled;

FIG. 12 is a flowchart illustrating a user setting reflection process in the digital camera;

FIG. 13 is a diagram illustrating a data structure for synchronous image stabilization in the digital camera;

FIG. 14 is a diagram showing a display example of a stabilization power setting selection screen in a digital camera according to a second embodiment;

FIG. 15 is a diagram illustrating a data structure of stabilization power management information in the digital camera according to the second embodiment;

FIG. 16 is a diagram showing a display example of a stabilization power setting screen in a digital camera according to a third embodiment;

FIG. 17 is a diagram for explaining a user setting reflection process in the digital camera according to the third embodiment; and

FIG. 18 is a block diagram illustrating a configuration of an imaging system according to a modification.

### DETAILED DESCRIPTION

Hereinafter, embodiments of the present disclosure will be described with reference to the relevant drawings. However, in the detailed description, unnecessary portions of the description relating to the prior art and the substantially identical configuration may be omitted. This is to simplify the description. The following description and the accompanying drawings are disclosed to enable those skilled in the art to fully understand the present disclosure and are not intended to limit the subject matter of the claims.

### First Embodiment

In a first embodiment, an example of a lens-interchangeable digital camera having a image stabilization function will be described as an example of an imaging apparatus.

### 1. Configuration

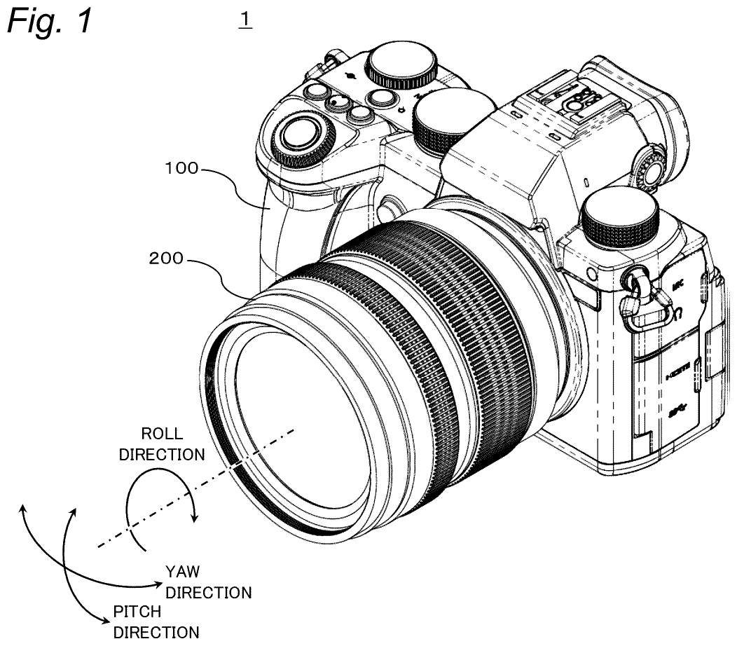

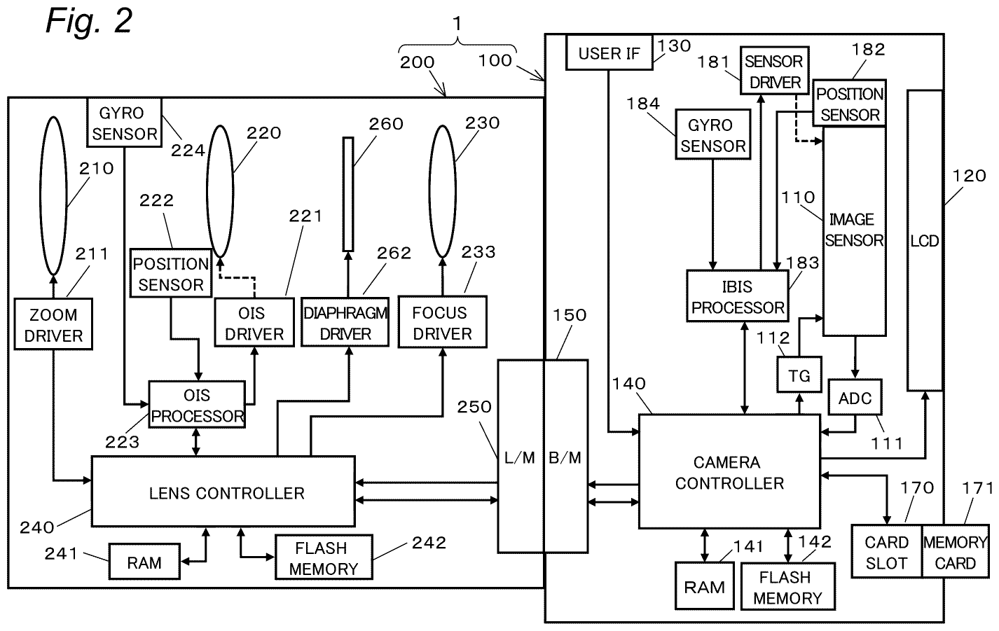

FIG. 1 is a perspective view of a digital camera 1 according to the first embodiment. FIG. 2 is a block diagram showing the configuration of the digital camera 1 according to the first embodiment. The digital camera 1 includes a camera body 100 and an interchangeable lens 200 attachable to and detachable from the camera body 100.

In the following description, a function of moving a correction lens in the interchangeable lens 200 to correct shake will be referred to as an “optical image stabilizer (OIS) function”. A function of moving an image sensor in the camera body 100 to correct shake will be referred to as a “in-body image stabilizer (IBIS) function”.

In the following description, directions of rotation corresponding to the horizontal direction and the vertical direction of the image sensor in the digital camera 1 are referred to as a yaw direction and a pitch direction, respectively, and a direction of rotation by a rotation axis along an optical axis of the digital camera 1 is referred to as a roll direction (cf. FIG. 1).

### 1-1. Camera Body

The camera body 100 (an example of an imaging apparatus) includes an image sensor 110, a liquid crystal monitor 120, a user interface 130, a camera controller 140, a body mount 150, and a card slot 170.

The camera controller 140 controls the entire operation of the digital camera 1 by controlling constituents, such as the image sensor 110, in response to an instruction from a release button. The camera controller 140 transmits a vertical synchronization signal to a timing generator (TG) 112. In parallel with this, the camera controller 140 generates an exposure synchronization signal. The camera controller 140 periodically transmits the generated exposure synchronization signal to a lens controller 240 through the body mount 150 and a lens mount 250. The camera controller 140 uses a dynamic random-access memory (DRAM) (or RAM) 141 as a work memory during control operation and image processing operation.

The image sensor 110 is an example of an image sensor that generates image data by capturing a subject image incident through the interchangeable lens 200. For example, the image sensor 110 is a charge-coupled device (CCD), a complementary metal-oxide-semiconductor (CMOS) image sensor, or an N-type metal-oxide-semiconductor (NMOS) image sensor. The generated image data is digitized by an AD converter (ADC) 111. The digitized image data is subjected to predetermined image processing by the camera controller 140. For example, the predetermined image processing is gamma correction processing, white balance correction processing, scratch correction processing, YC conversion processing, electronic zoom processing, or JPEG compression processing.

The image sensor 110 operates at a timing controlled by the timing generator 112. The image sensor 110 generates a still image or a moving image for recording or a through image. The through image is mainly a moving image and is displayed on the liquid crystal monitor 120 so that a user determines a composition for capturing the still image.

The liquid crystal monitor 120 displays an image such as a through image and various information such as a menu screen. The liquid crystal monitor 120 is an example of a display in the present embodiment. Other types of display devices, such as an organic light-emitting (EL) display device, may be used in place of the liquid crystal monitor.

The user interface 130 includes various operation members, such as a release button for instructing the start of shooting, a mode dial for setting a shooting mode, and a power switch. The user interface 130 also includes a touch panel disposed overlapping the liquid crystal monitor 120.

The card slot 170 can have the memory card 171 placed therein, and controls the memory card 171 on the basis of the control from the camera controller 140. The digital camera 1 can store image data into the memory card 171 and read image data from the memory card 171.

The body mount 150 is mechanically and electrically connectable to the lens mount 250 of the interchangeable lens 200. The body mount 150 is capable of transmitting and receiving data to and from the interchangeable lens 200 through the lens mount 250. The body mount 150 transmits an exposure synchronization signal received from the camera controller 140 to the lens controller 240 through the lens mount 250. The body mount 150 transmits other control signals received from the camera controller 140 to the lens controller 240 through the lens mount 250. The body mount 150 transmits a signal received from the lens controller 240 to the camera controller 140 through the lens mount 250.

The camera body 100 further includes, as a configuration for achieving the IBIS function, a gyro sensor 184 (shake detector) for detecting the shake of the camera body 100, and an IBIS processor 183 for controlling shake correction processing on the basis of the detection result of the gyro sensor 184. The camera body 100 further includes a sensor driver 181 for moving the image sensor 110, and a position sensor 182 for detecting the position of the image sensor 110.

For example, the sensor driver 181 can be produced with a magnet and a flat plate coil. The sensor driver 181 may include others such as a motor or an actuator. The position sensor 182 is a sensor for detecting the position of the image sensor 110 in a plane perpendicular to the optical axis of the optical system. The position sensor 182 can be produced with a magnet and a Hall element, for example.

The IBIS processor 183 controls the sensor driver 181 on the basis of a signal from the gyro sensor 184 and a signal from the position sensor 182 to shift the image sensor 110 into the plane perpendicular to the optical axis so that the shake of the camera body 100 is canceled out. The range in which the image sensor 110 can be driven by the sensor driver 181 is limited mechanistically. The range in which the image sensor 110 can be driven by the sensor driver 181 in the IBIS function will be referred to as an “element drive range”.

### 1-2. Interchangeable Lens

The interchangeable lens 200 includes the optical system, the lens controller 240, and the lens mount 250. The optical system includes a zoom lens 210, an optical image stabilizer (OIS) lens 220, a focus lens 230, and a diaphragm 260.

The zoom lens 210 is a lens for changing a magnification of a subject image formed by the optical system. One or more lenses are included in the zoom lens 210. The zoom lens 210 is driven by a zoom driver 211. The zoom driver 211 includes a zoom ring operable by the user. Alternatively, the zoom driver 211 may include a zoom lever and an actuator or a motor. The zoom driver 211 moves the zoom lens 210 along the optical-axis direction of the optical system in accordance with an operation by the user.

The focus lens 230 is a lens for changing a focus state of a subject image formed on the image sensor 110 in an optical system. One or more lenses are included in the focus lens 230. The focus lens 230 is driven by a focus driver 233.

The focus driver 233 includes an actuator or a motor, and moves the focus lens 230 along the optical axis of the optical system under the control of the lens controller 240. The focus driver 233 can be produced with a direct-current (DC) motor, a stepping motor, a servo motor, an ultrasonic motor, or the like.

The OIS lens 220 is a lens for correcting the shake of a subject image formed by the optical system of the interchangeable lens 200 in the OIS function. The OIS lens 220 moves in a direction to cancel out the shake of the digital camera 1 to reduce the shake of the subject image on the image sensor 110. One or more lenses are included in the OIS lens 220. The OIS lens 220 is driven by an OIS driver 221.

By receiving the control of an OIS processor 223, the OIS driver 221 shifts the OIS lens 220 in the plane perpendicular to the optical axis of the optical system. The range in which the OIS lens 220 can be driven by the OIS driver 221 is limited mechanistically. The range in which the OIS lens 220 can be driven by the OIS driver 221 will be referred to as a “lens drive range”. The OIS driver 221 can be produced with a magnet and a flat plate coil, for example. A position sensor 222 is a sensor for detecting the position of the OIS lens 220 in the plane perpendicular to the optical axis of the optical system. The position sensor 222 can be produced with a magnet and a Hall element, for example. The OIS processor 223 controls the OIS driver 221 on the basis of an output of the position sensor 222 and an output of a gyro sensor 224 (shake detector).

The diaphragm 260 adjusts the amount of light incident on the image sensor 110. A diaphragm driver 262 drives the diaphragm 260 to control the size of its aperture. The diaphragm driver 262 includes a motor or an actuator.

The gyro sensor 184 or 224 detects shake (vibration) in the yaw direction, the pitch direction, and the roll direction on the basis of an angular change per unit time, that is, an angular velocity, of the digital camera 1. The gyro sensor 184 or 224 outputs an angular velocity signal indicating the detected amount of shake (angular velocity) to the IBIS processor 183 or the OIS processor 223. The angular velocity signal output by the gyro sensor 184 or 224 may include a wide range of frequency components caused by camera shake, mechanical noise, and the like. Other sensors capable of detecting the shake of the digital camera 1 may be used in place of the gyro sensor. The gyro sensor 224 of the interchangeable lens 200 need not detect shake in the roll direction.

The camera controller 140 and the lens controller 240 may each be formed of a hard-wired electronic circuit or a microcomputer using a program. For example, the camera controller 140 and the lens controller 240 may be produced with various processors, such as a central processing unit (CPU), a microprocessor unit (MPU), a graphics processing unit (GPU), a digital signal processor (DSP), a field-programmable gate array (FPGA), or an application specific integrated circuit (ASIC).

### 1-3. Image Stabilization Mechanism

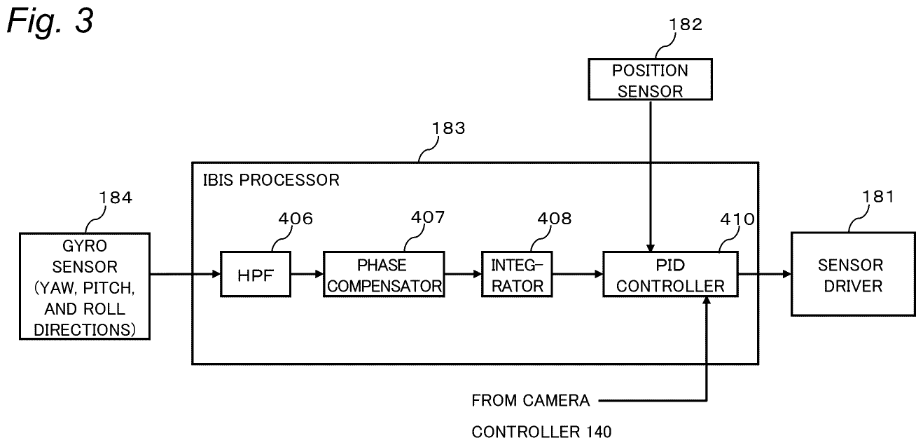

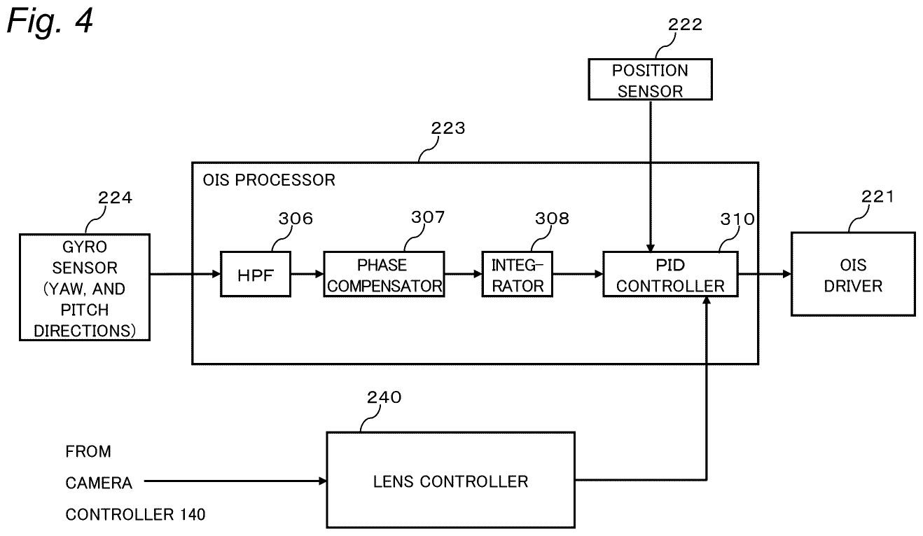

A image stabilization mechanism, which is a configuration for achieving various image stabilization functions of the digital camera 1 in the present embodiment, will be described with reference to FIGS. 3 and 4.

FIG. 3 is a block diagram showing the configuration of the IBIS processor 183 in the digital camera 1 according to the present embodiment. FIG. 4 is a block diagram showing the configuration of the OIS processor 223 in the digital camera 1.

### 1-3-1. IBIS Processor

The configuration of the IBIS processor 183 in the camera body 100 will be described with reference to FIG. 3. The IBIS processor 183 includes a high-pass filter (HPF) 406, a phase compensator 407, an integrator 408, and a PID controller 410.

In order to block a drift component, the HPF 406 blocks a predetermined low-frequency component included in a signal received from the gyro sensor 184, for example.

The phase compensator 407 corrects, for a signal received from the HPF 406, a phase delay caused by the sensor driver 181 or the like.

The integrator 408 integrates the signal indicating the angular velocity of the shake (vibration) input from the phase compensator 407 to generate a signal indicating the angle of the shake (vibration) (hereinafter referred to as a “shake detection signal”). The shake detection signal from the integrator 408 is input to the PID controller 410. Here, the IBIS processor 183 may use or add a filter configuration other than the above configuration, such as a low-pass filter (LPF).

On the basis of the output from the position sensor 182 and the output from the integrator 408, the PID controller 410 generates a drive signal for shifting the image sensor 110 and outputs the generated signal to the sensor driver 181. The sensor driver 181 drives the image sensor 110 on the basis of the drive signal. For example, the PID controller 410 generates a drive signal so as to perform PID control on the basis of the difference between the shake detection signal from the integrator 408 and the current position information of the sensor driver 181.

In the IBIS processor 183 of the present embodiment, when a correction coefficient, such as a stabilization power or a correction ratio to be described later, is set from the camera controller 140, the PID controller 410 generates a drive signal indicating a shake correction amount obtained by multiplying a shake correction amount for canceling out the entire difference by the correction coefficient, for example. In this way, the IBIS processor 183 of the present embodiment can perform image stabilization reflecting the correction coefficient.

### 1-3-2. OIS Processor

Referring to FIG. 4, the configuration of the OIS processor 223 in the interchangeable lens 200 will be described. The OIS processor 223 includes a high pass filter (HPF) 306, a phase compensator 307, an integrator 308, and a PID controller 310.

The HPF 306 blocks a predetermined low-frequency component included in a signal received from the gyro sensor 224 in order to block a drift component, for example.

The phase compensator 307 corrects, for a signal received from the HPF 306, a phase delay caused by the OIS driver 221 or the like.

The integrator 308 integrates a signal indicating the angular velocity of the shake input from the phase compensator 307 to generate a shake detection signal indicating the angle of the shake. The shake detection signal from the integrator 308 is input to the PID controller 310. Here, the OIS processor 223 may use or add a filter configuration other than the above configuration such as an LPF.

For example, The PID controller 310 performs PID control on the basis of the difference between the shake detection signal and the current position information of the OIS lens 220 received from the position sensor 222, to generates a drive signal for the OIS driver 221. The OIS driver 221 drives the OIS lens 220 on the basis of the drive signal.

In the OIS processor 223 of the present embodiment, when a correction coefficient is set from the lens controller 240, the PID controller 310 generates a drive signal indicating a shake correction amount obtained by multiplying a shake correction amount for canceling out the entire difference by the correction coefficient, for example. The lens controller 240 receives the correction coefficient from the camera controller 140 via the lens mount 250, for example. In this way, the OIS processor 223 of the present embodiment can perform image stabilization reflecting the correction coefficient set from the camera controller 140.

### 2. Operations

The operation of the digital camera 1 configured as described above will be described below.

The digital camera 1 of the present embodiment performs various operations to dare to weaken a stabilization power that is the degree of image stabilization in the image stabilization operation, for the user preference of leaving a certain degree of camera shake to produce a sense of dynamism at shooting of a moving image, for example. An operation for image stabilization in the digital camera 1 of the present embodiment will be described below.

### 2-1. Overall Operation

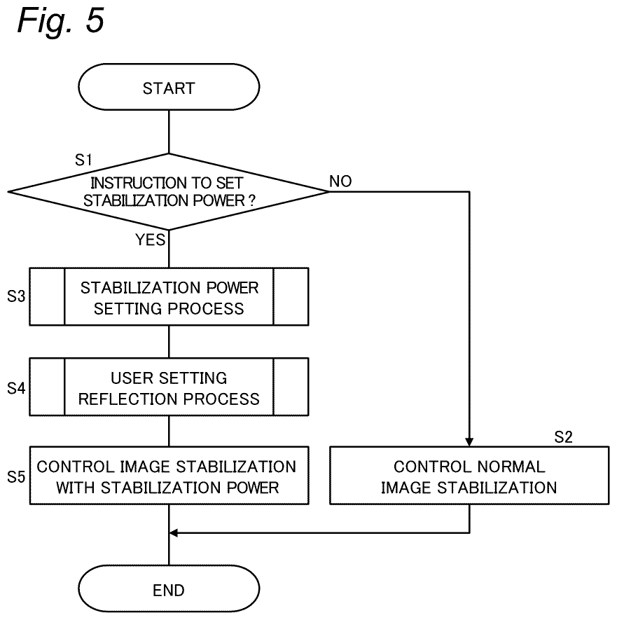

The overall operation of the image stabilization in the digital camera 1 of the present embodiment will be described with reference to FIGS. 5 to 7.

FIG. 5 is a flowchart illustrating the operation of the digital camera 1 according to the present embodiment. The processing shown in the flowchart of FIG. 5 is executed by the camera controller 140 of the digital camera 1, for example.

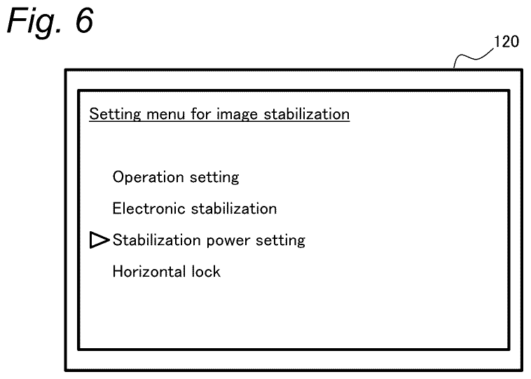

In the digital camera 1 of the present embodiment, first, the camera controller 140 receives a user operation instructing to set the stabilization power via the user interface 130, for example (S1). The instruction to set the stabilization power in step S1 is performed by a user operation in a setting menu of the digital camera 1, for example. FIG. 6 shows a display example of the digital camera 1 in step S1.

FIG. 6 illustrates a setting menu for image stabilization in the digital camera 1. For example, the liquid crystal monitor 120 of the digital camera 1 displays a menu item such as “Stabilization power setting” or “Horizontal lock” in the setting menu in FIG. 6. For example, the user can input an instruction to select the menu item “Stabilization power setting” from such a setting menu to the user interface 130 (YES in S1).

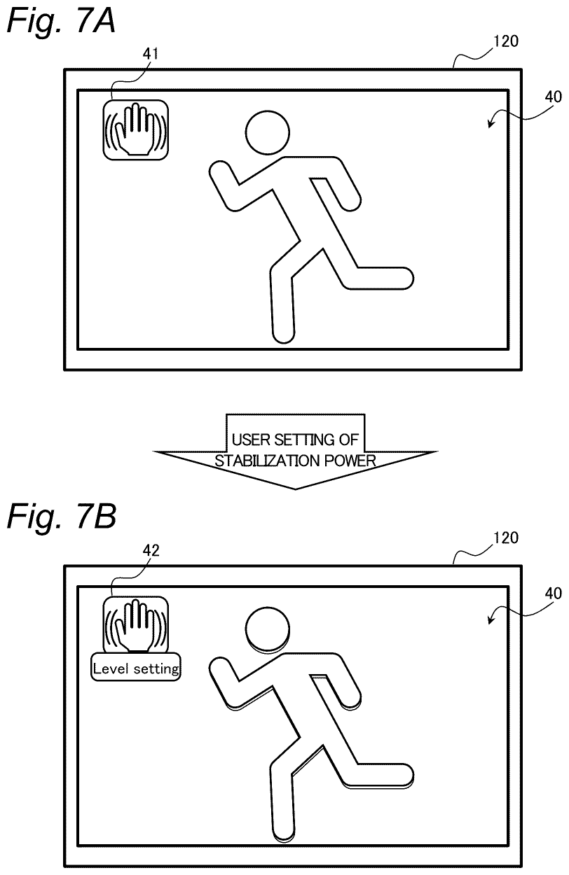

When the instruction to set the stabilization power is not input (NO in S1), the camera controller 140 performs normal image stabilization control without particularly setting the stabilization power in the shooting mode for shooting a moving image or a still image, for example (S2). FIG. 7A shows a display example of step S2.

FIG. 7A shows an example of a live view screen displayed in the shooting mode of the digital camera 1. For example, as shown in FIG. 7A, the live view screen in step S2 includes a through image 40 and a image stabilization icon 41. For example, the live view screen is displayed in a shooting standby state or a shooting state of the digital camera 1. The through image 40 is a moving image captured in real time by the image sensor 110. The image stabilization icon 41 indicates that the image stabilization operation is being executed.

In step S2, the camera controller 140 causes the liquid crystal monitor 120 to display the live view screen in FIG. 7A, and execute control of various shooting modes such as image stabilization control, for example. In step S2, it is possible to shoot a moving image or the like in which the maximum image stabilization is performed without particularly setting (i.e., limiting) the stabilization power.

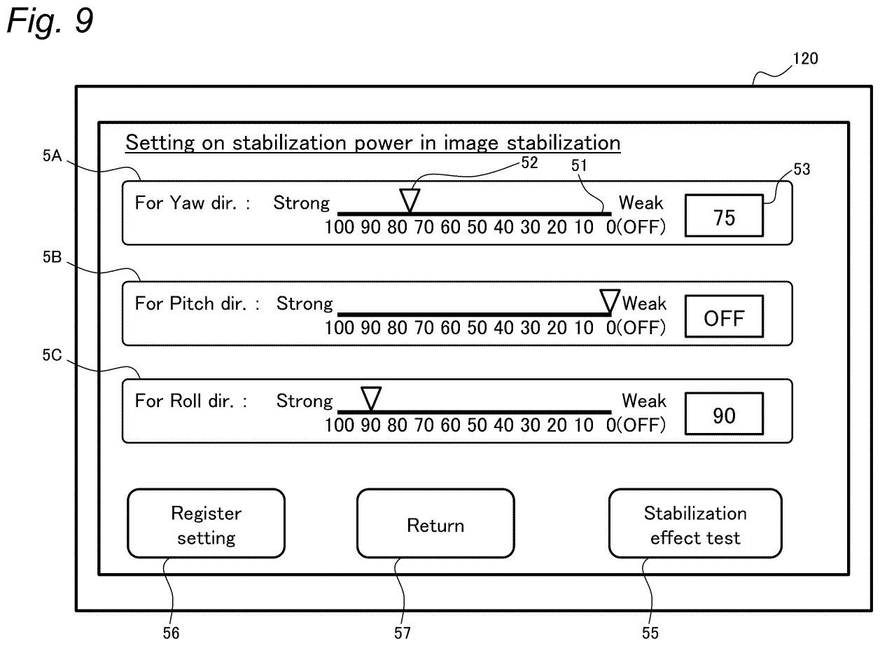

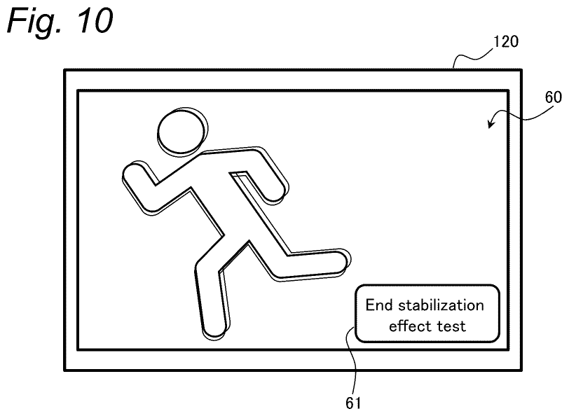

On the other hand, when the instruction to set the stabilization power is input (YES in S1), the camera controller 140 receives a user operation for adjusting the stabilization power, and sets the stabilization power in the digital camera 1 in accordance with the user operation (S3). In the stabilization power setting process (S3) according to the present embodiment, in order to achieve the degree of effect of the image stabilization desired by the user, the digital camera 1 provides an operation mode in which the user can adjust the stabilization power in various directions and check the state under adjustment (cf. FIG. 9 to 10). Details of the stabilization power setting process (S3) will be described later.

Next, based on the result of the stabilization power setting process (S3), the camera controller 140 reflects the stabilization power set by the user in the image stabilization mechanism (S4). In the user setting reflection process (S4) in the present embodiment, the user setting stabilization power is applied to the IBIS processor 183 and/or the OIS processor 223 in accordance with the characteristics of the interchangeable lens 200 mounted on the camera body 100. Details of the user setting reflection process (S4) will be described later.

Next, in accordance with the processing results of steps S3 and S4, the camera controller 140 performs image stabilization control with the set stabilization power, in the operation of the shooting mode similar to step S2, for example (S5). FIG. 7B shows a display example of the digital camera 1 in step S5.

FIG. 7B illustrates a live view screen when the stabilization power is set in the digital camera 1. The live view screen in step S5 includes a image stabilization icon 42 with the level setting, instead of the normal image stabilization icon 41 in the live view screen (FIG. 7A) in step S2. The image stabilization icon 42 is an example of identification information indicating a state in which the image stabilization control limited by the stabilization power setting is being executed.

With the display of the image stabilization icon 42 for the limited level on the live view screen (FIG. 7B) in step S5, the user can easily understand a state in which the digital camera 1 in use is operating with intentionally weakened image stabilization, and thus the camera shake may remain in the through image 40. The camera controller 140 performs various controls in the shooting mode similar to step S2, with moderating the image stabilization control to reflect the stabilization power set by the user in step S4 (S5). In step S5, the IBIS/OIS processor 183, 223 executes the image stabilization operation similarly to step S2 in a state (S4) where the stabilization power is limited to the stabilization power set by the user.

The camera controller 140 ends the processing of the flowchart illustrated in FIG. 5 after execution of various controls such as the image stabilization control in steps S2 and S5.

According to the operation of the digital camera 1 described above, the stabilization power desired by the user is set in the digital camera 1 (S3), and the image stabilization control in which the stabilization power is weakened is performed in accordance with the user setting (S4). Therefore, the digital camera 1 of the present embodiment can easily achieve the image stabilization in which the camera shake is intentionally left according to the user preference.

The image stabilization icons 41, 42 in steps S2 and S5 described above are examples, and are not limited to the display examples of FIGS. 7A and 7B, and may be in various display forms. The display forms of the image stabilization icons 41, 42 may be changed in accordance with the type of image stabilization, and for example, a state of both or one of the IBIS and the OIS in operation may be identified and displayed. When the image stabilization operation is stopped (OFF) in the digital camera 1, the image stabilization icons 41, 42 may not be displayed.

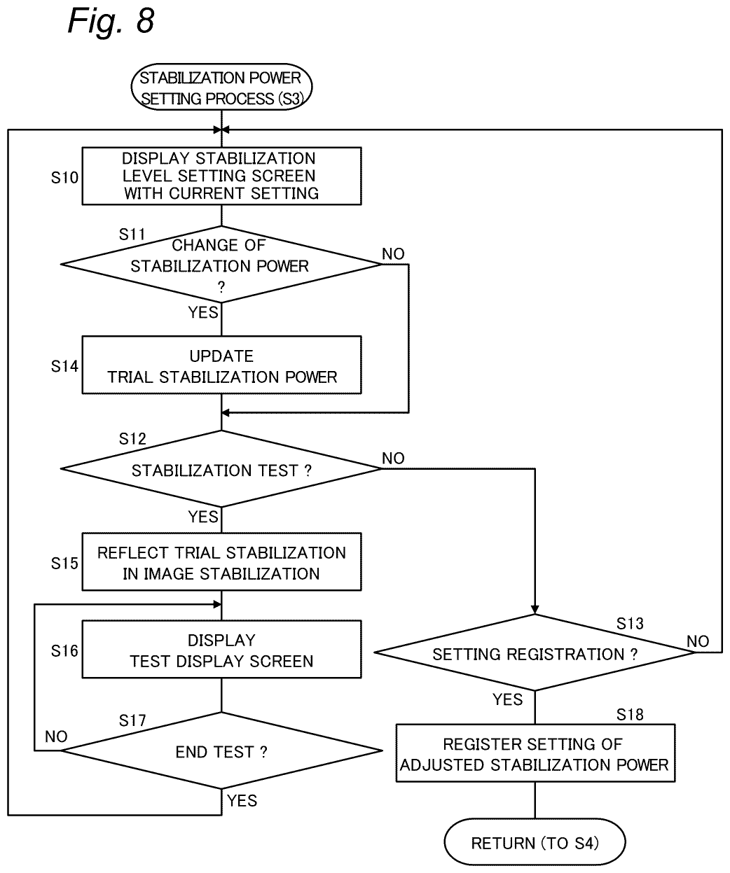

2-2. Stabilization power setting process Details of the stabilization power setting process in step S3 in FIG. 8 will be described with reference to FIGS. 8 to 11. FIG. 8 is a flowchart illustrating the stabilization power setting process (S3) in the digital camera 1 according to the present embodiment.

First, the camera controller 140 acquires the current setting information in the digital camera 1 from a flash memory 142, and causes the liquid crystal monitor 120 to display a screen for performing a user setting of the stabilization power on the basis of the acquired setting information, for example (S10). FIG. 9 illustrates a display example of such a stabilization power setting screen.

In the digital camera 1 of the present embodiment, as shown in FIG. 9, the stabilization power setting screen includes a yaw adjuster 5A, a pitch adjuster 5B, a roll adjuster 5C, a stabilization effect test button 55, a setting registration button 56, and a return button 57, for example. Each of the adjusters 5A to 5C is a portion for receiving adjustment of various stabilization powers on the stabilization power setting screen.

The yaw adjuster 5A receives a user operation for adjusting the stabilization power in the image stabilization in the yaw direction. The pitch adjuster 5B receives a user operation for adjusting the stabilization power in the image stabilization in the pitch direction. The roll adjuster 5C receives a user operation for adjusting the stabilization power in the image stabilization in the roll direction.

The respective adjusters 5A to 5C are configured to allow setting of the stabilization powers in the respective directions using numerical values with the maximum state of the image stabilization as 100% and the OFF state as 0%, for example. For example, each of the adjusters 5A to 5C includes a stabilization power bar 51, an adjustment head 52, and a setting display field 53.

The stabilization power bar 51 displays the range of possible stabilization power settings from 100%, the strongest stabilization power, to 0%, the weakest stabilization power, for example. The adjustment head 52 receives a user operation for changing the stabilization power by moving the position on the stabilization power bar 51, for example.

The setting display field 53 displays the stabilization power in accordance with the position of the adjustment head 52 on the stabilization power bar 51 as a setting value being adjusted. For example, the camera controller 140 manages a setting value indicating a trial stabilization power, which is the stabilization power under the adjustment, in the RAM 141 on the execution of the stabilization power setting process (S3). For example, the initial value of the trial stabilization power is 100%.

For example, with the setting screen in FIG. 9 displayed on the liquid crystal monitor 120, the camera controller 140 receives, on the user interface 130, various user operations on the setting screen (S11 to S13). For example, the camera controller 140 determines whether an operation for changing the stabilization power related to camera shake in various directions is input on the stabilization power setting screen (FIG. 9) (S11).

The operation for changing the stabilization power in step S11 is a user operation for changing the setting value for the trial stabilization power, and is achieved by a touch operation in each of the adjusters 5A to 5C via the touch panel in the user interface 130, for example. For example, the user can input, to the digital camera 1, an operation for moving the adjustment head 52 to a desired position on the stabilization power bar 51 in each of the yaw adjuster 5A, the pitch adjuster 5B, and the roll adjuster 5C by a touch operation on the stabilization power setting screen (FIG. 9) (S11).

When such an operation for changing the stabilization power is input (YES in S11), the camera controller 140 updates the setting value for the trial stabilization power in accordance with the position of the adjustment head 52 after the movement, for example (S14). In step S14, the camera controller 140 rewrites the setting value for the stabilization power managed in the RAM 141 to update the display of the setting display field 53 to a new setting value being adjusted, for example.

The camera controller 140 determines whether the stabilization power setting screen (FIG. 9) receives a user input of the operation of the stabilization effect test button 55 (S12). The stabilization effect test button 55 receives a user operation for executing a test mode that is an operation mode to test the effect of the trial stabilization power by a touch operation, for example.

When the user operates the stabilization effect test button 55 (YES in S12), the camera controller 140 reflects the trial stabilization power in the image stabilization mechanism (S15). In step S15, the camera controller 140 performs a process similar to that in step S4 in FIG. 5 on the basis of the setting value being adjusted, managed in the RAM 141, and further starts the image stabilization operation reflecting the trial stabilization power, for example.

Moreover, the camera controller 140 causes the liquid crystal monitor 120 to transition from the stabilization power setting screen (FIG. 9) and display a screen for the test mode (S16). FIG. 10 illustrates a display example of the digital camera 1 in step S16.

For example, as shown in FIG. 10, the test display screen includes a through image 60 and a correction effect test end button 61. The through image 60 in step S16 is captured by the image sensor 110 on the execution of the image stabilization operation (S15) reflecting the trial stabilization power. With such a test display screen (FIG. 10) displaying the through image 60, the user can specifically visually recognize the degree of effect of image stabilization using the stabilization power of the setting value currently being adjusted.

The camera controller 140 determines whether the operation of the correction effect test end button 61 is input with the test display screen (FIG. 10) displayed, for example (S17). The correction effect test end button 61 receives a user operation for ending the test mode by a touch operation, for example.

When the operation of the correction effect test end button 61 has not been input (NO in S17), the camera controller 140 repeats the process in and after step S16 in a predetermined period (e.g., a frame period). In this way, the test display screen of the through image 60 in the image stabilization reflecting the trial stabilization power is sequentially updated and displayed (S16).

On the other hand, when the operation of the correction effect test end button 61 is input (YES in S17), the camera controller 140 returns to step S10, for example. In this way, in the digital camera 1 of the present embodiment, the stabilization power setting screen (FIG. 9) is again displayed on the liquid crystal monitor 120 with the setting value being adjusted, which was used for the test display screen, and various user operations can be input to the screen on the user interface 130.

For example, with the stabilization power setting screen (FIG. 9) displayed, the camera controller 140 determines whether the operation of the setting registration button 56 is input (S13). The setting registration button 56 receives a user operation for registering a setting value as an adjustment result of the stabilization power by a touch operation, for example.

When the user operates the setting registration button 56 (YES in S13), the camera controller 140 performs setting registration of the stabilization power as the adjustment result (S18). For example, the camera controller 140 stores the final setting value for the stabilization power managed in the RAM 141 in the setting information in the flash memory 142 (S18).

When setting the stabilization power as the adjustment result by the user setting (S18), the camera controller 140 ends the stabilization power setting process (S3 in FIG. 5), and proceeds to a user setting reflection process (S4) for image stabilization control in the digital camera 1.

According to the stabilization power setting process (S3) described above, the digital camera 1 of the present embodiment receives, on the stabilization power setting screen (S10), a user operation for the user to adjust the stabilization power in detail (S11). In this way, the digital camera 1 of the present embodiment can facilitate setting of the stabilization power, which reaches the degree of effect of the image stabilization desired by the user, in the digital camera 1.

For example, the digital camera 1 of the present embodiment can set a desired stabilization power with a sense of dynamism for a shooting scene where a cameraman runs or walks with shooting a moving image. For example, in a shooting scene where the cameraman runs behind a subject for shooting the image of the subject, it might be desirable to leave a certain degree of shake in the vertical direction to give a sense of dynamism, while firmly correcting shake in each of the other directions. In this case, the digital camera 1 of the present embodiment can achieve desired image stabilization with improved image quality of the scene, by a user setting in which the stabilization power for the pitch direction is adjusted to “30%” and the stabilization powers in the yaw direction and the roll direction are adjusted to “100%”, for example.

As another example, in a shooting scene where the cameraman walks alongside a walking subject for shooting the profile of the subject, it might be desirable to weaken the stabilization power in the lateral direction, while performing image stabilization in each of the other directions at the maximum level. In this case, the digital camera 1 of the present embodiment can achieve desired image stabilization according to the shooting scene by a user setting in which the stabilization power for the yaw direction is adjusted to “50%” and the stabilization power for the pitch direction and the roll direction is adjusted to “100%”, for example. According to the digital camera 1 of the present embodiment, various stabilization powers can be adjusted without being limited to the above example, and image stabilization corresponding to the user's intention can be easily achieved.

In the digital camera 1 of the present embodiment, the stabilization powers in the yaw direction, the pitch direction, and the roll direction can be individually adjusted by the adjusters 5A to 5C on the stabilization power setting screen, for example (FIG. 9). For example, the digital camera 1 of the present embodiment can facilitate checking the stabilization powers in the respective directions quantitatively by the numerical value settings for the stabilization powers in the respective adjusters 5A to 5C, resulting in having the reproducibility of the stabilization power settings.

In the example of FIG. 9, in the pitch adjuster 5B, the adjustment head 52 is at 0%, the weakest position on the stabilization power bar 51, and OFF is indicated in the setting display field 53. In such a setting, the camera controller 140 controls the image stabilization mechanism so as to stop the image stabilization in the pitch direction.

As described above, in the digital camera 1 of the present embodiment, in each of the adjusters 5A to 5C, the setting to stop the image stabilization in the direction can be easily shifted by the user operation for moving the adjustment head 52 to the weakest position in the stabilization power bar 51. According to this, a simple menu operation can be achieved, with reducing the load that would be caused by the complicated menu operation as in the case where the image stabilization is turned on/off in the menu item different from the stabilization power setting, for example.

According to the test mode in the present embodiment, the user can move from the stabilization power setting screen (FIG. 9) to the test display screen (FIG. 10) by operating the stabilization effect test button 55 (YES in S12), and can immediately check the effect of the trial stabilization power. It is also easy to return from the test display screen (FIG. 10) to the stabilization power setting screen (FIG. 9) by operating the correction effect test end button 61 (YES in S17).

In contrast, if no test mode, a load would be caused by a complicated menu operation such as switching back and forth between the live view screen and the setting menu to check the effect of the trial stabilization power. According to the digital camera 1 of the present embodiment, such a burden caused by a complicated menu operation can be avoided, and the stabilization power can be easily adjusted.

In the digital camera 1 of the present embodiment, the user operation on the stabilization power setting screen (FIG. 9) or the test display screen (FIG. 10) is not particularly limited to the touch operation. For example, instead of the touch operation, the operations in steps S11 to S13 and S17 may be input to the digital camera 1 by physical button operations or key operations on the user interface 130.

The user operation received on the stabilization power setting screen (FIG. 9) by the digital camera 1 of the present embodiment is not limited to the operations in steps S11 to S13, and for example, an operation of the return button 57 for interrupting the stabilization power setting process (S3) may be input. When the return button 57 is operated in the example of FIG. 9, the camera controller 140 causes the liquid crystal monitor 120 to transition to the display screen before the start of the stabilization power setting process (S3) without performing stabilization power setting registration (S18), and returns to step S1 in FIG. 5, for example.

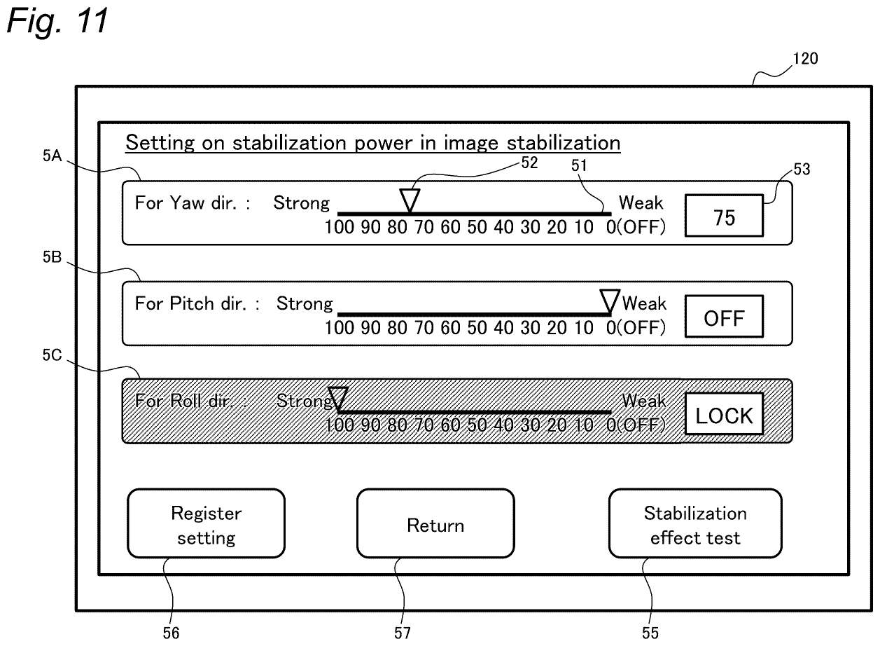

In the present embodiment, the stabilization power setting process (S3) may be performed by reflecting the settings of various functions in the digital camera 1. Such a modification will be described with reference to FIG. 11.

FIG. 11 illustrates a stabilization power setting screen when a horizontal lock function in the digital camera 1 is set to ON (enabled). The horizontal lock function is a function of using the image stabilization mechanism in the roll direction so as to maintain the horizontal view angle with respect to the attitude of the digital camera 1. When the horizontal lock function is ON, the stabilization power for the roll direction is fixed to 100%, for example.

On the basis of such a setting of the horizontal lock function, in the stabilization power setting process (S3), the camera controller 140 controls the roll adjuster 5C to be in a display form indicating that a user setting is not possible, such as a grayed-out state, as shown in FIG. 11, and displays a stabilization power setting screen, for example (S10). Moreover, in step S11, the camera controller 140 does not receive a user operation on the roll adjuster 5C and invalidates the user operation. In the setting display field 53 of the roll adjuster 5C, a state in which the stabilization power is fixed by the horizontal lock function may be identified and displayed.

### 2-3. User Setting Reflection Process

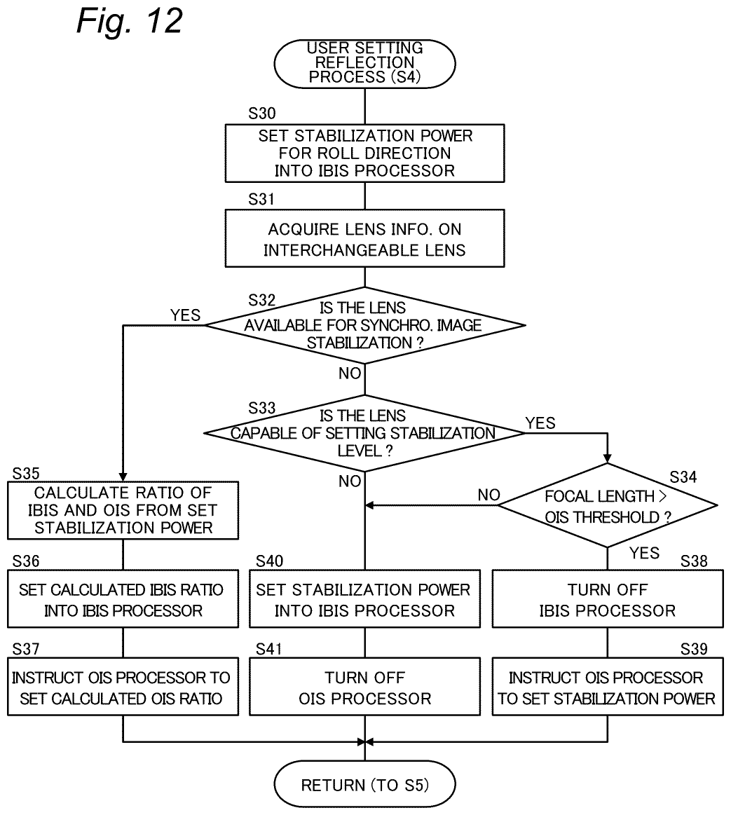

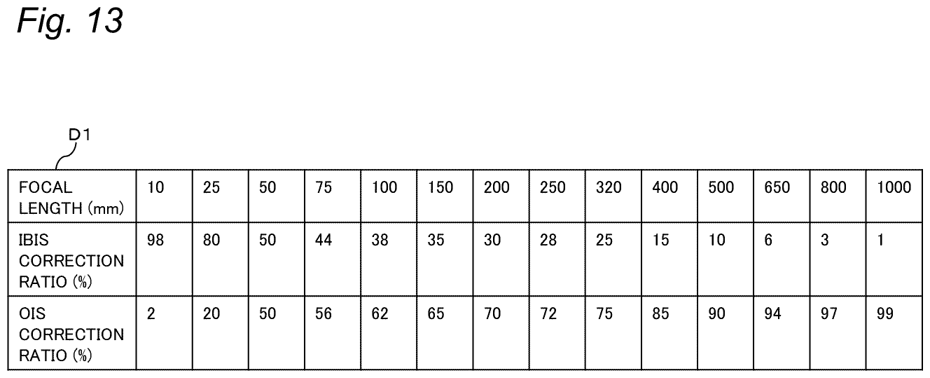

With reference to FIGS. 12 and 13, a description will be given of the user setting reflection process (S4) performed on the lens-interchangeable image stabilization mechanism in accordance with the result of the stabilization power setting process (S3 in FIG. 5) in the digital camera 1 of the present embodiment.

FIG. 12 is a flowchart illustrating the user setting reflection process (S4) in the digital camera 1 according to the present embodiment. FIG. 13 is a diagram illustrating a data structure for synchronous image stabilization in the digital camera 1.

First, the camera controller 140 sets the stabilization power for the roll direction into the IBIS processor 183, for example (S30). On the other hand, the stabilization powers in the yaw direction and the pitch direction are set in one or both of the IBIS processor 183 and the OIS processor 223 in accordance with the characteristics of the interchangeable lens 200.

For example, the camera controller 140 acquires lens information regarding the interchangeable lens 200 mounted on the camera body 100 (S31). For example, the lens information in step S31 includes whether the interchangeable lens 200 can perform synchronous image stabilization, whether the interchangeable lens 200 can set the stabilization power, and the current focal length of the interchangeable lens 200.

In step S31, the camera controller 140 may receive the lens information from the interchangeable lens 200 via the body mount 150. Alternatively, such information may be received when the interchangeable lens 200 is mounted on the camera body 100 or when the power of the digital camera 1 is turned on. The lens information thus obtained may be stored in the flash memory 142, and the camera controller 140 may read the stored information from the flash memory 142 in step S31.

Referring to the acquired lens information, the camera controller 140 determines whether the interchangeable lens 200 mounted on the camera body 100 is available for synchronous image stabilization (S32). The synchronous image stabilization is image stabilization performed by the IBIS processor 183 of the camera body 100 and the OIS processor 223 of the interchangeable lens 200 in synchronization. The synchronous image stabilization of the digital camera 1 will be described with reference to FIG. 13.

FIG. 13 illustrates a data structure of correction ratio data D1 for synchronous image stabilization in the digital camera 1. For example, as shown in FIG. 13, synchronous image stabilization is performed using an IBIS correction ratio and an OIS correction ratio. The IBIS correction ratio indicates the distribution of the IBIS processor 183 in the synchronous image stabilization. The OIS correction ratio indicates the distribution of the OIS processor 223 in the synchronous image stabilization.

In the correction ratio data D1 in FIG. 13, the IBIS correction ratio and the OIS correction ratio are set to be 100% in total, particularly for normal synchronous image stabilization in which the stabilization power is not set. The correction ratio data D1 manages the correspondence between the IBIS correction ratio and the OIS correction ratio for each focal length of the digital camera 1, for example. Such correction ratio data D1 is stored in advance in the flash memory 142 of the camera body 100, for example.

For example, the normal synchronous image stabilization is performed by the camera controller 140 referring to the correction ratio data D1 and setting the IBIS correction ratio and the OIS correction ratio corresponding to the current focal length of the digital camera 1 in the IBIS/OIS processor 183, 223. The IBIS processor 183 performs image stabilization at a ratio corresponding to the set IBIS correction ratio of the entire image stabilization amount that cancels out the camera shake amount of the digital camera 1. The OIS processor 223 performs image stabilization at a ratio corresponding to the set OIS correction ratio in the entire image stabilization amount. In this way, the entire digital camera 1 can perform image stabilization corresponding to the entire image stabilization amount. The correction ratio may be set separately for the yaw direction and the pitch direction.

Returning to FIG. 12, when the interchangeable lens 200 is available for the synchronous image stabilization (YES in S32), the camera controller 140 calculates a substantial distribution between the IBIS and the OIS on the basis of the set stabilization power, the correction ratio data D1, and the current focal length (S35).

In step S35, the camera controller 140 acquires the IBIS correction ratio and the OIS correction ratio corresponding to the current focal length from the correction ratio data D1 and multiplies each of the IBIS correction ratio and the OIS correction ratio by (1/100 times) the stabilization power, for example. For example, for an IBIS correction ratio of 30% and an OIS correction ratio of 70% in the case of a focal length of 200 mm, when the stabilization power is 70%, the substantial IBIS distribution is calculated to be 21%, and the OIS distribution is calculated to be 49%. For example, the calculation in step S35 is performed for the yaw direction and the pitch direction on the basis of the respective stabilization powers.

Next, the camera controller 140 sets the calculated IBIS distribution to the IBIS processor 183 as a correction coefficient instead of the IBIS correction ratio, for example (S36). In this way, the IBIS processor 183 performs image stabilization in accordance with the set IBIS distribution instead of the IBIS correction ratio.

The camera controller 140 transmits an instruction to the interchangeable lens 200 via the body mount 150 to set the calculated OIS distribution to the OIS processor 223 (S37). In step S37, the lens controller 240 of the interchangeable lens 200 sets the OIS distribution received from the camera body 100 via the lens mount 250 to the OIS processor 223. The OIS processor 223 performs image stabilization in accordance with the set OIS distribution instead of the OIS correction ratio.

According to the settings in steps S36 and S37, the synchronous image stabilization of the IBIS processor 183 and the OIS processor 223 enables the entire digital camera 1 to perform the image stabilization limited at a ratio corresponding to the stabilization power from the entire image stabilization amount.

On the other hand, when the interchangeable lens 200 is not available for the synchronous image stabilization (NO in S32), the camera controller 140 determines whether the interchangeable lens 200 is capable of setting the stabilization power on the basis of the lens information acquired in step S31 (S33).

When the interchangeable lens 200 is capable of setting the stabilization power (YES in S33), the camera controller 140 determines whether the current focal length is larger than a predetermined OIS threshold (S34). For example, the OIS threshold is set in advance to a reference focal length at which it is assumed that the OIS processor 223 can perform image stabilization more efficiently than the IBIS processor 183, and is in the range of 50 to 1000 mm, for example (cf. FIG. 13).

When the current focal length is larger than the OIS threshold (YES in S34), the camera controller 140 sets the IBIS processor 183 to OFF (disabled), for example (S38). In this case, the IBIS processor 183 stops the image stabilization operation.

The camera controller 140 transmits an instruction to the interchangeable lens 200 via the body mount 150 to turn on (enable) the OIS processor 223 and set the stabilization power set by the user (S39). In step S39, the lens controller 240 sets the OIS processor 223 in accordance with an instruction from the camera body 100. In this way, the OIS processor 223 performs the image stabilization limited according to the set stabilization power.

On the other hand, when the current focal length is equal to or less than the OIS threshold (NO in S34), the camera controller 140 turns on the IBIS processor 183 and sets the stabilization power set by the user (S40). In this case, the IBIS processor 183 performs the image stabilization limited according to the set stabilization power.

The camera controller 140 transmits an instruction to the interchangeable lens 200 via the body mount 150 to set the OIS processor 223 to OFF (S41). In step S41, the lens controller 240 controls the OIS processor 223 so as not to operate in accordance with an instruction from camera body 100. In this way, the OIS processor 223 stops the image stabilization operation.

When the interchangeable lens 200 is not capable of setting the stabilization power (NO in S33), the camera controller 140 turns on the IBIS processor 183 and sets the stabilization power set by the user (S40). The camera controller 140 transmits an instruction to set the OIS processor 223 to OFF (S41).

After setting the IBIS processor 183 and the OIS processor 223 as described above, the camera controller 140 ends the user setting reflection process (S4) shown in the flowchart of FIG. 12, and proceeds to step S5 in FIG. 5, for example. In this way, the digital camera 1 performs the operation in the shooting mode in the image stabilization operation limited by the set stabilization power (S5).

According to the user setting reflection process (S4) described above, the digital camera 1 of the present embodiment sets the stabilization power of the user setting in one or both of the IBIS processor 183 and the OIS processor 223 in accordance with the characteristics of the mounted interchangeable lens 200 (S36 to S41). As a result, in the lens-interchangeable digital camera 1, the stabilization power set by the user can be reflected in the image stabilization operation by utilizing the characteristics of the interchangeable lens 200.

In the digital camera 1 of the present embodiment, some of the processes shown in the flowchart of FIG. 12 are not limited to being performed after the stabilization power setting process (S3), and may be performed in advance. For example, the camera controller 140 may perform some or all of the processes in steps S31 to S34 when the lens information can be acquired from the interchangeable lens 200.

### 3. Review

As described above, the digital camera 1 and the camera body 100, each of which is an example of the imaging apparatus in the present embodiment, include: the image sensor 110 that is an example of an image sensor; the IBIS processor 183 or the OIS processor 223 that is an example of an image stabilizer; the liquid crystal monitor 120 that is an example of a display; the user interface 130; and the camera controller 140 that is an example of a controller. The image sensor 110 captures a subject image via the interchangeable lens 200 including various optical systems. The image stabilizer performs image stabilization in accordance with the camera shake of the imaging apparatus. The liquid crystal monitor 120 displays an image captured by the image sensor 110. The user interface 130 receives a user operation. The camera controller 140 controls the image stabilizer on the basis of a user operation on the user interface 130. The camera controller 140 causes the liquid crystal monitor 120 to display a stabilization power setting screen (FIG. 9), which is an example of a setting screen on which the stabilization power indicating the degree of performing the image stabilization is set (S10). The camera controller 140 then receives, on the user interface 130, a user operation on the setting screen, and sets the stabilization power in accordance with the user operation (S11 to S18).

According to the above imaging apparatus, image stabilization according to the user preference can be easily achieved by receiving a user operation and setting the stabilization power on the stabilization power setting screen.

In the present embodiment, the camera controller 140 has a test mode, which is an example of a first operation mode activated before the stabilization power is set on the setting screen. In the test mode, the image stabilizer performs the image stabilization with a limitation in accordance with the trial stabilization power on the setting screen (S15), and the liquid crystal monitor 120 displays the through image 60, which is an example of an image captured by the image sensor 110, upon the image stabilization in accordance with the trial stabilization power (S16). According to such a test mode, the user of the digital camera 1 can view the degree of effect of image stabilization using the trial stabilization power, and can easily achieve image stabilization according to the user preference.

In the present embodiment, the camera controller 140 causes the liquid crystal monitor 120 to transition from the setting screen to the display screen in the test mode, that is, the test display screen, in accordance with the operation of the stabilization effect test button 55, which is an example of a first user operation on the stabilization power setting screen (YES in S12). The camera controller 140 returns the liquid crystal monitor 120 from the test display screen to the stabilization power setting screen (SS10) in accordance with the operation of the correction effect test end button 61, which is an example of a second user operation, on the test display screen (YES in S17). This enables the user to easily transition the digital camera 1 between the stabilization power setting screen and the test display screen, and to easily adjust the stabilization power.

In the present embodiment, the camera controller 140 has a shooting mode, which is an example of a second operation mode different from the test mode. In the shooting mode after the stabilization power is set, the image stabilizer causes the image stabilization to be performed with a limitation according to the set stabilization power (S5), and the liquid crystal monitor 120 displays the through image 40, which as an example of an image captured by image sensor 110, upon the image stabilization in accordance with the set stabilization power (cf. FIG. 7B). This enables the user to check the effect of the trial stabilization power in the test mode different from the shooting mode, and to easily adjust the stabilization power.

In the present embodiment, the stabilization power setting screen includes various adjusters 5A to 5C, which are examples of a plurality of adjusters. The various adjusters 5A to 5C adjust, as an example of a plurality of types of stabilization power different from each other, stabilization powers for camera shake components in the yaw direction, the pitch direction, and the roll direction, respectively. The camera controller 140 receives user operations on the plurality of adjusters 5A to 5C on the respective stabilization power setting screen, and sets stabilization powers adjusted in the respective adjusters 5A to 5C (cf. S11 to S18 in FIG. 9). This enables the user of the digital camera 1 to independently adjust the stabilization powers for the image stabilization in various directions, and to easily achieve the image stabilization desired by the user.

In the present embodiment, the camera controller 140 invalidates a user operation on the roll adjuster 5C among the plurality of adjusters 5A to 5C, in accordance with a state where the horizontal lock function is enabled, which is an example of a predetermined setting state related to an attitude of the imaging apparatus (cf. FIG. 11). As a result, the stabilization power can be adjusted without interfering with the horizontal lock function, and the image stabilization desired by the user can be easily achieved.

In the present embodiment, when the type of stabilization power corresponding to one of the plurality of adjusters 5A to 5C is adjusted to 0%, which is an example of a predetermined value, the camera controller 140 performs a setting to turn off (stop) the image stabilization of that type (cf. 5B in FIG. 9). This enables the user to also perform a setting for stopping the image stabilization in various directions on the stabilization power setting screen, and to easily achieve the image stabilization desired by the user.

In the present embodiment, the camera body 100 further includes a body mount 150, which is an example of a communication interface on which the interchangeable lens 200 including an optical system is mounted, the communication interface performing data communication with the mounted interchangeable lens 200. The camera controller 140 sets stabilization power in at least one of the camera body 100 or the interchangeable lens 200 on the basis of lens information, which is an example of information received from the interchangeable lens 200 via the body mount 150 (S4). As a result, in the lens-interchangeable digital camera 1, the image stabilization desired by the user can be easily achieved.

In the present embodiment, the image stabilizer is the IBIS processor 183, which is an example of a first image stabilizer, and the interchangeable lens 200 includes the OIS processor 223, which is an example of a second image stabilizer. The OIS processor 223 shifts the OIS lens 220, which is an example of a correction lens included in the optical system, to perform image stabilization. The camera controller 140 sets the stabilization power in the camera body 100 and the interchangeable lens 200 so as to limit, to the stabilization power, the image stabilization simultaneously performed by the IBIS processor 183 and the OIS processor 223 (S35 to S37). As a result, the stabilization power can be reflected in the synchronous image stabilization performed by the IBIS processor 183 and the OIS processor 223, and the image stabilization desired by the user can be easily achieved.

In the present embodiment, the camera controller 140 sets the stabilization power in the imaging apparatus or the interchangeable lens 200 so as to switch between the IBIS processor 183 and the OIS processor 223 and operate the switched processor in accordance with the focal length of the interchangeable lens 200 (S34, S38 to S41). As a result, even when the IBIS processor 183 or the OIS processor 223 is switched and used, the stabilization power set by the user can be reflected, and the image stabilization desired by the user can be easily achieved.

In the present embodiment, when determining that the stabilization power is not capable of setting in the interchangeable lens 200 on the basis of the information received from the interchangeable lens 200 via the body mount 150 (NO in S33), the camera controller 140 sets the stabilization power in the camera body 100 (S40 to S41). As a result, the image stabilization desired by the user can be easily achieved, as the image stabilization reflecting the stabilization power set by the user can be performed even with the interchangeable lens 200 in which the stabilization power cannot be set, for example.

In the present embodiment, the camera controller 140 causes the liquid crystal monitor 120 to display the image stabilization icon 42 for the level setting as an example of identification information indicating whether the stabilization power is set upon the image stabilization by the image stabilizer (S5). This enables the user to explicitly understand that the imaging apparatus is in a state where the stabilization power is set, and to easily use the image stabilization in accordance with the stabilization power.

### Second Embodiment

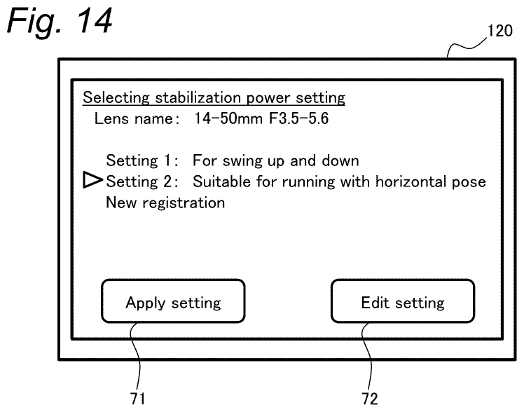

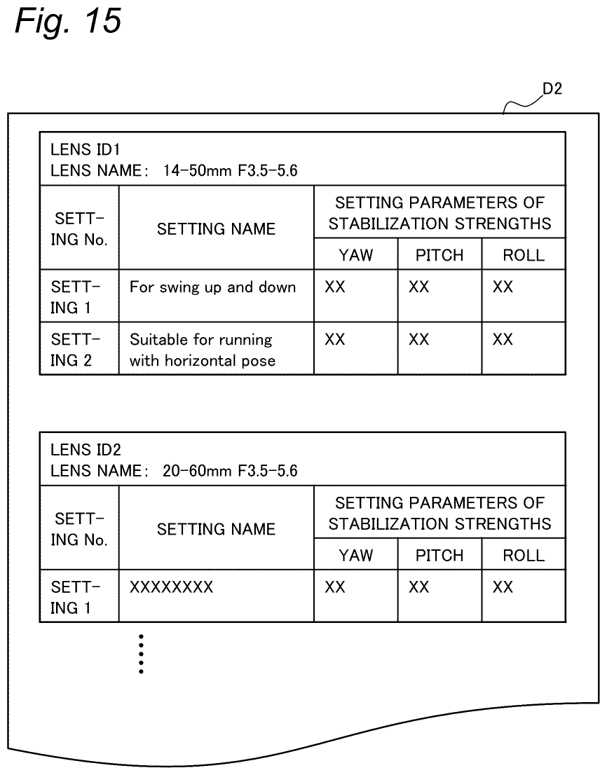

Hereinafter, a second embodiment of the present disclosure will be described with reference to FIGS. 14 and 15. In the first embodiment, the digital camera 1 in which a user setting of the stabilization power is performed has been described. In the second embodiment, a digital camera 1 that can register a plurality of settings of the stabilization power will be described.

The digital camera 1 according to the present embodiment will be described below by omitting descriptions of configurations and operations similar to those of the digital camera 1 according to the first embodiment.

FIG. 14 shows a display example of a stabilization power setting selection screen in the digital camera 1 according to the second embodiment. The digital camera 1 of the present embodiment provides a user with a selectable result of past setting registration (S18 in FIG. 8) in a stabilization power setting process (S3) similar to that of the first embodiment, for example. For example, when the menu item “Stabilization power setting” is selected from the setting menu (cf. FIG. 6), a stabilization power setting selection screen illustrated in FIG. 14 is displayed on the liquid crystal monitor 120 before the stabilization power setting screen (FIG. 9) is displayed (S10 in FIG. 8).

The selection screen in FIG. 14 includes user-selectable options such as “Setting 1”, “Setting 2”, and “New registration”, as well as a setting application button 71 and a setting edit button 72. For example, “Setting 1” has a setting name “For swing up and down”, and the setting value for the stabilization power is recorded accordingly. The digital camera 1 of the present embodiment manages such a setting of the stabilization power for each interchangeable lens 200.

FIG. 15 illustrates a data structure of stabilization power management information D2 in the digital camera 1 according to the second embodiment. For example, as shown in FIG. 15, the stabilization power management information D2 records various settings of the stabilization power for each interchangeable lens 200 in association with a lens identification (ID) for identifying the interchangeable lens 200. The stabilization power management information D2 is stored in the flash memory 142 of the digital camera 1, for example.

For example, on the basis of the lens ID of the mounted interchangeable lens 200, the camera controller 140 reads the stabilization power setting with which the lens ID matches in the stabilization power management information D2, and causes the stabilization power selection screen to display corresponding options (FIG. 14). In the example of FIG. 15, the stabilization power management information D2 manages a “setting number”, a “setting name”, and a “stabilization power setting parameter” in association with each other for each lens ID. The stabilization power setting parameter includes a setting value for the stabilization power in each of the yaw, pitch, and roll directions, for example.

On the selection screen in FIG. 14, when the user operates the setting application button 71 withe an option such as “setting 1” or “setting 2” selected, the camera controller 140 reflects the setting value for the stabilization power according to the option in the image stabilization mechanism as in the first embodiment, for example. Thus, in the digital camera 1 of the present embodiment, the setting of the previously adjusted stabilization power can be immediately used.

On the other hand, when the setting edit button 72 is operated with such an option as described above selected, the camera controller 140 causes the liquid crystal monitor 120 to transition to the stabilization power setting screen with the setting value for the selected stabilization power as the initial value, for example.

When the user selects the option “New registration”, the camera controller 140 causes the liquid crystal monitor 120 to transition to the stabilization power setting screen at a predetermined initial value, for example. Thereafter, the camera controller 140 receives an input of a name for the newly registered setting, when the setting registration button 56 is operated, for example. The camera controller 140 updates the stabilization power management information D2 so as to store such a new setting of the stabilization power.

As described above, in the present embodiment, the digital camera 1 or the camera body 100 further includes the flash memory 142 that stores the stabilization power management information D2 as an example of management information for managing a setting value for the stabilization power and the interchangeable lens 200 in association with each other. As a result, the stabilization power setting can be managed for each interchangeable lens 200 to be mounted, and the stabilization power desired by the user can be easily achieved.

### Third Embodiment

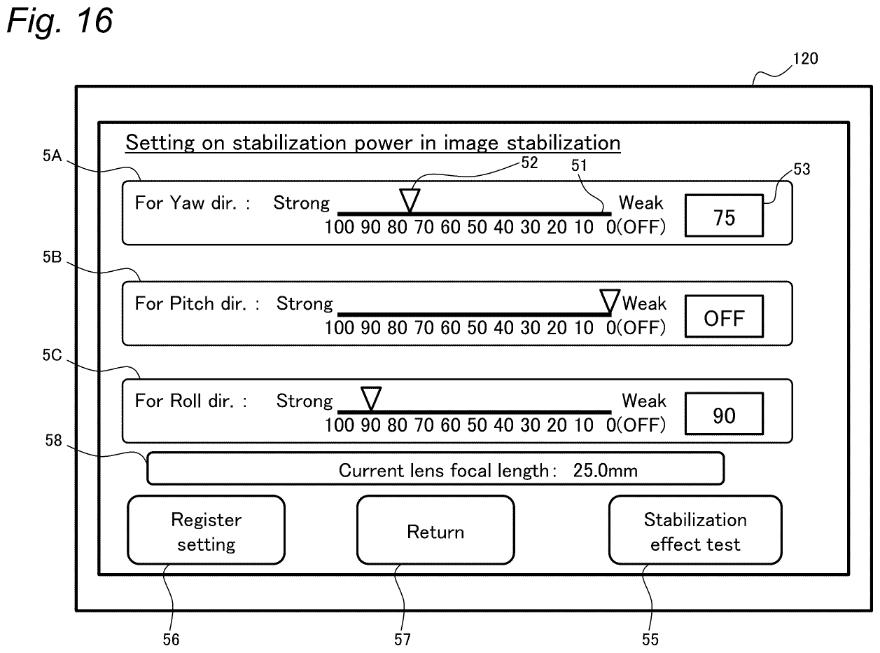

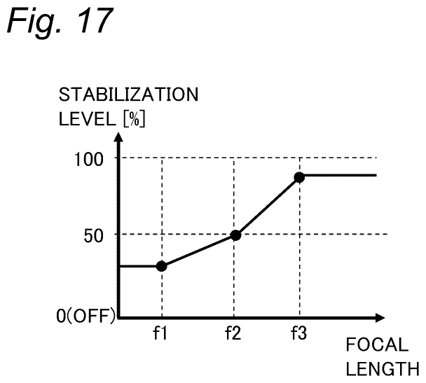

Hereinafter, a third embodiment of the present disclosure will be described with reference to FIGS. 16 and 17. In the interchangeable lens 200 having a variable focal length, the stabilization power may be set for each focal length. In the third embodiment, a modification of the digital camera 1 will be described.

The digital camera 1 according to the present embodiment will be described below by omitting descriptions of configurations and operations similar to those of the digital camera 1 according to the first and second embodiments.

FIG. 16 shows a display example of a stabilization power setting screen in the digital camera 1 according to the third embodiment. The digital camera 1 of the present embodiment receives a user setting of the stabilization power in association with the focal length of the interchangeable lens 200 in the stabilization power setting process (S3) similar to that of the first embodiment, for example.

For example, the stabilization power setting screen in the present embodiment further includes a focal length field 58 for displaying the current focal length as shown in FIG. 16 in a configuration similar to that of the setting screen in FIG. 9. For example, the camera controller 140 sequentially receives the current focal length from the interchangeable lens 200 via the body mount 150 and causes the received focal length to be displayed in the focal length field 58.

When the stabilization power setting screen in the present embodiment is displayed, the user can input, in the digital camera 1, a user operation for adjusting the stabilization power with a desired focal length achieved by operating the zoom ring of the interchangeable lens 200, for example. Thus, in the digital camera 1 of the present embodiment, the camera controller 140 acquires the user setting of the stabilization power in the state of the focal length corresponding to one or more points in the interchangeable lens 200.

In the digital camera 1 of the present embodiment, sequentially referring to the current focal length of the interchangeable lens 200 in the shooting mode after the user setting as described above, the camera controller 140 reflects the stabilization power corresponding to the focal length in the image stabilization mechanism to perform image stabilization control, for example.

FIG. 17 is a diagram for explaining a user setting reflection process in the digital camera 1 according to the third embodiment. The example of FIG. 17 illustrates a case where the user setting of the stabilization power is performed at each of focal lengths f1, f2, f3 corresponding to three points.

In the digital camera 1 of the present embodiment, the camera controller 140 performs interpolation between the focal lengths f1 and f2 (or f2 and f3) corresponding to two adjacent points, to calculate the stabilization power in accordance with the focal length, as illustrated in FIG. 17, for example. For the focal length smaller than the minimum focal length f1 among the user settings, the camera controller 140 adopts the same stabilization power as the minimum focal length f1, for example. For the focal length larger than the maximum focal length f2 among the user settings, the camera controller 140 adopts the same stabilization power as the maximum focal length f2, for example. The stabilization power for each focal length can be appropriately managed as a stabilization power setting parameter in the stabilization power management information D2, for example.

As described above, in the digital camera 1 of the present embodiment, the optical system includes the zoom lens 210 that changes the focal length. On the stabilization power setting screen, the camera controller 140 receives a user operation for adjusting the stabilization power in accordance with the focal length of the optical system, and sets the stabilization power (cf. FIG. 16). Therefore, even when the focal length is changed in the digital camera 1, the stabilization power is set in a timely manner, and the image stabilization desired by the user can be easily achieved.

Other Embodiments As the above, the first to third embodiments have been described as examples of the techniques disclosed in the present application. However, the technique in the present disclosure is not limited thereto, and can also be applied to embodiments in which change, replacement, addition, omission, and the like are made as appropriate. Each of the constituents described in the first to third embodiments can be combined to form a new embodiment. Other embodiments will be described below.

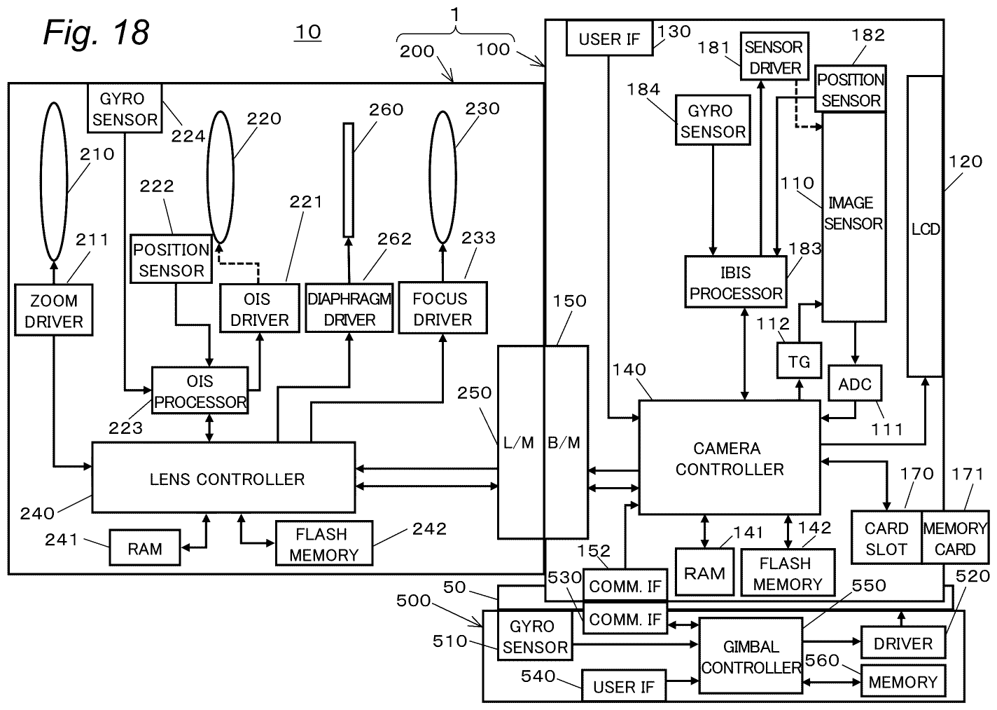

In the first to third embodiments described above, the example in which the stabilization power is set when image stabilization is performed in the digital camera 1 has been described, but the present disclosure is not limited thereto. When image stabilization is performed by the external configuration of the digital camera 1, the stabilization power may be set in the external configuration of the digital camera 1. Such a modification will be described with reference to FIG. 18.

FIG. 18 illustrates a configuration of an imaging system 10 according to a modification. The imaging system 10 includes the digital camera 1 and a gimbal device 500 that achieves a image stabilization function by attitude control of the digital camera 1. For example, the digital camera 1 of the present embodiment further includes a communication interface 152 that performs data communication with the gimbal device 500 in the camera body 100 in addition to a configuration similar to that of the first embodiment.

The gimbal device 500 is a device for rotatably supporting the digital camera 1. For example, as shown in FIG. 18, the gimbal device 500 includes a camera supporting member 50, a gyro sensor 510, a driver 520, a communication interface 530, a user interface 540, a gimbal controller 550, and a memory 560. The gimbal device 500 also includes a grip (not shown) for a user to grasp, for example.

The camera supporting member 50 includes a mounting base on which the digital camera 1 is detachably mounted. The camera supporting member 50 has a mechanism in which the mounted digital camera 1 is rotatably supported on three axes in the pitch, yaw, and roll directions, for example. The gyro sensor 510 of the gimbal device 500 is configured in the same manner as the gyro sensor 184 of the camera body 100, for example. The gyro sensor 510 detects angular velocities in the pitch, yaw, and roll directions, for example.

In the gimbal device 500, the driver 520 drives a portion of the camera supporting member 50 in the pitch, yaw, and roll directions so as to control the direction of the mounted digital camera 1, for example. The driver 520 includes a motor or an actuator for rotation drive in the three axial directions, for example. The communication interface 530 is a circuit for communicatively connecting the digital camera 1 to the gimbal device 500. The communication interface 530 receives and transmits various information from and to the communication interface 152 of the digital camera 1, in accordance with a predetermined communication standard. The user interface 540 includes an operation member such as a switch and a button provided on the exterior of the gimbal device 500, for example. In response to reception of an operation by the user, the user interface 540 transmits a signal corresponding to the user operation to the gimbal controller 550.

The gimbal controller 550 includes a CPU or the like, and controls the operation of the entire gimbal device 500, for example. The gimbal controller 550 reads data and programs stored in the memory 560, performs various arithmetic processing, and achieves various functions. The memory 560 is a recording medium for storing data, programs, and the like needed for achieving the function of the gimbal controller 550 and includes a flash memory, for example. The memory 560 may include random-access memory (RAM) and function as a work area for the gimbal controller 550 with temporarily storing data.

In such an imaging system 10, the digital camera 1 of the present embodiment may reflect the user setting of the stabilization power also in the image stabilization operation performed by the gimbal device 500, as in the above embodiments. For example, as in the case of the interchangeable lens 200 of the second embodiment, the camera controller 140 may manage the gimbal device 500 mounted on the digital camera 1. Such stabilization power management information of the gimbal device 500 is stored in the flash memory 142, for example.

In the digital camera 1 of the present embodiment, the camera controller 140 may identify the gimbal device 500 mounted on the digital camera 1 through data communication via the communication interface 152, as in the case of the interchangeable lens 200 of the second embodiment. As in the second embodiment, the camera controller 140 of the present embodiment may display a selection screen for presenting to the user the stabilization power set in the gimbal device 500 in the past, or may transmit an instruction to set the stabilization power in the gimbal device 500.

As described above, in the present embodiment, the digital camera 1 may further include the communication interface 152 that performs data communication with the gimbal device 500, and the flash memory 142 that stores management information for managing the setting value for the stabilization power and the gimbal device in association with each other. Therefore, the stabilization power can also be set for the image stabilization of the gimbal device 500, and the stabilization power desired by the user can be easily achieved.

In the above embodiments, the example in which the stabilization power setting screen includes the three adjusters 5A, 5B, 5C corresponding to the three directions of rotation such as the yaw direction, the pitch direction, and the roll direction has been described, but the digital camera 1 of the present embodiment is not particularly limited thereto. For example, the stabilization power setting screen of the present embodiment may be configured by omitting the adjuster in one of the three directions of rotation. That is, in the imaging apparatus of the present embodiment, the plurality of types of stabilization powers may include a degree of image stabilization in one or more of the yaw direction, the pitch direction, and the roll direction in the imaging apparatus.

Alternatively, in the digital camera 1 of the present embodiment, the plurality of types of stabilization power is not limited to the direction of rotation, and may include a stabilization power in the translation direction. That is, in the digital camera 1 of the present embodiment, the plurality of types of stabilization power may include a degree of image stabilization in one or both of the horizontal translation direction and the vertical translation direction in the digital camera 1. In the digital camera 1 of the present embodiment, an adjuster that adjusts stabilization power for each frequency component, such as a high-frequency component or a low-frequency component, may be used.

In the first embodiment described above, an example of the synchronous image stabilization has been described with reference to FIG. 13, but the synchronous image stabilization in the digital camera 1 of the present embodiment is not limited to the above example. For example, in the digital camera 1 of the present embodiment, the IBIS processor 183 and the OIS processor 223 may perform synchronous image stabilization for sharing a high-frequency component and a low-frequency component of the camera shake. In the case of setting the stabilization power in such synchronous image stabilization, the camera controller 140 may set the stabilization power common to the IBIS processor 183 and the OIS processor 223, instead of the IBIS distribution and the OIS distribution in steps S35 to S37.

In the above embodiments, the IBIS processor 183 has been described as an example of the image stabilizer in the camera body 100, but the present embodiment is not limited thereto. The camera body 100 of the present embodiment may include an electronic image stabilizer (EIS) processor that implements an EIS function as a functional configuration of the camera controller 140, for example. The EIS function is a function of correcting shake by adjusting a region from which image data is cut out by the image sensor. The image stabilizer of the present embodiment may be such an EIS processor. The EIS processor may include an image processing circuit. When the OIS processor 223 is operated in the digital camera 1, a configuration such as the body mount 150 that transmits an instruction regarding image stabilization from the camera body 100 to the interchangeable lens 200 may function as the image stabilizer in the camera body 100.

In the above embodiments, the stabilization power setting screen is illustrated in FIG. 9 or the like as an example of the setting screen of the digital camera 1, but the setting screen of the present embodiment is not particularly limited thereto. The setting screen of the present embodiment is not particularly limited to full-screen display, and may be displayed as various windows, dialogs, or pop-ups, or may be superimposed and displayed on various display screens.

The adjuster on the setting screen of the present embodiment is not limited to the configuration illustrated in FIG. 9 or the like, and need not be configured to change the position of the adjustment head 52 on the stabilization power bar 51, for example. For example, an increase/decrease button for numerical value input or the like may be used, or a selection form of an option other than numerical values may be used for the stabilization power. The setting display field 53 may be appropriately excluded from the adjuster.

In the above embodiments, the lens-interchangeable digital camera has been described as an example of the imaging apparatus; however, the imaging apparatus of the present embodiment may be a digital camera that is not particularly a lens-interchangeable type. The idea of the present disclosure may not only be a digital camera but also be a movie camera and can also be applied to electronic device having various image shooting functions such as a portable telephone with a camera, a smartphone, or a personal computer (PC).

### Aspect Examples

Hereinafter, various aspects of the present disclosure will be exemplified.

A first aspect according to the present disclosure is an imaging apparatus including: an image sensor that captures a subject image via an optical system; an image stabilizer that performs image stabilization responding to shake of the imaging apparatus; a display that displays an image captured by the image sensor; a user interface that receives a user operation; and a controller that controls the image stabilizer, based on the user operation in the user interface. The controller causes the display to display a setting screen for setting stabilization power indicating a degree to perform the image stabilization, and receives the user operation on the setting screen in the user interface, to set the stabilization power in accordance with the user operation.

A second aspect is the imaging apparatus according to the first aspect, wherein the controller has a first operation mode activated before the stabilization power is set on the setting screen. In the first operation mode, the image stabilizer performs the image stabilization with moderating in accordance with a trial stabilization power that is under adjustment on the setting screen, and the display displays the image captured by the image sensor with the image stabilization performed in accordance with the trial stabilization power.

A third aspect is the imaging apparatus according to the second aspect, wherein the controller causes the display to transition from the setting screen to a display screen for the first operation mode in accordance with a first user operation on the setting screen, and returns the display from the display screen for the first operation mode to the setting screen in accordance with a second user operation on the display screen for the first operation mode.

A fourth aspect is the imaging apparatus according to the second or third aspect, wherein the controller has a second operation mode different from the first operation mode. In the second operation mode after the stabilization power is set, the image stabilizer performs the image stabilization with moderating in accordance with the set stabilization power, and the display displays the image captured by the image sensor with the image stabilization performed in accordance with the set stabilization power.

A fifth aspect is the imaging apparatus according any one of the first to fourth aspects, wherein the setting screen includes a plurality of adjusters that respectively adjust a plurality of types of stabilization powers different from each other. The controller receives user operations on the plurality of adjusters in the setting screen, to set the respective types of stabilization powers adjusted in the respective adjusters.

A sixth aspect is the imaging apparatus according the fifth aspect, wherein the plurality of types of stabilization powers include a degree of the image stabilization in at least one of a yaw direction, a pitch direction, or a roll direction in the imaging apparatus.

A seventh aspect is the imaging apparatus according the fifth or sixth aspect, wherein the plurality of types of stabilization powers include a degree of the image stabilization in at least one of a horizontal translation direction or a vertical translation direction in the imaging apparatus.

An eighth aspect is the imaging apparatus according any one of the fifth to seventh aspects, wherein the controller disallows a specific user operation on a specific adjuster among the plurality of adjusters, in accordance with a predetermined setting state for a pose of the imaging apparatus.

A ninth aspect is the imaging apparatus according any one of the fifth to eighth aspects, wherein, when a type of stabilization power corresponding to one of the plurality of adjusters is adjusted to a predetermined value, the controller performs a setting to stop the image stabilization of the type.

A tenth aspect is the imaging apparatus according any one of the first to ninth aspects, further including a communication interface mountable of an interchangeable lens to communicate data with the interchangeable lens mounted thereon, the interchangeable lens including the optical system. The controller sets the stabilization power in at least one of the imaging apparatus or the interchangeable lens, based on the data received from the interchangeable lens via the communication interface.

An eleventh aspect is the imaging apparatus according the tenth aspect, wherein the image stabilizer is a first image stabilizer. The interchangeable lens includes a second image stabilizer that performs image stabilization by shifting a correction lens included in the optical system. The controller sets the stabilization power to the imaging apparatus and the interchangeable lens, to moderate dual image stabilization by the stabilization power, the dual image stabilization being simultaneously performed by the first image stabilizer and the second image stabilizer.

A twelfth aspect is the imaging apparatus according the tenth or eleventh aspect, wherein the image stabilizer is a first image stabilizer. The interchangeable lens includes a second image stabilizer that performs image stabilization by shifting a correction lens included in the optical system. The controller sets the stabilization power to the imaging apparatus and the interchangeable lens, to switch operation between the first image stabilizer and the second image stabilizer in accordance with a focal length of the interchangeable lens.

A thirteenth aspect is the imaging apparatus according any one of the tenth to twelfth aspects, wherein the controller sets the stabilization power to the imaging apparatus, when determining that the stabilization power is not settable to the interchangeable lens, based on the data received from the interchangeable lens via the communication interface.

A fourteenth aspect is the imaging apparatus according any one of the tenth to thirteenth aspects, further including a memory that stores management information to manage a setting value for the stabilization power and the interchangeable lens in association with each other.

A fifteenth aspect is the imaging apparatus according any one of the first to fourteenth aspects, wherein the controller causes the display to display identification information indicating whether the stabilization power is set with the image stabilization performed by the image stabilizer.

A sixteenth aspect is the imaging apparatus according any one of the first to fifteenth aspects, wherein the optical system includes a zoom lens that changes a focal length. The controller receives, on the setting screen, the user operation adjusting the stabilization power in accordance with the focal length of the optical system, to set the stabilization power.

A seventeenth aspect is the imaging apparatus according any one of the first to sixteenth aspects, further including: a communication interface that communicates data with a gimbal device mounted on the imaging apparatus; and a memory that stores management information to manage a setting value for the stabilization power and the gimbal device in association with each other.

As described above, the embodiments have been described as examples of the techniques in the present disclosure. To that end, the accompanying drawings and detailed description thereof have been provided.

Therefore, the constituents described in the accompanying drawings and the detailed description may include not only constituents essential for achieving an object of the present disclosure but also constituents not essential for achieving it, for the purpose of exemplifying the above techniques. Thus, those non-essential constituents should not be immediately recognized as essential by the fact that those non-essential constituents are described in the accompanying drawings or in the detailed description.

With the above embodiments being intended to illustrate the techniques in the present disclosure, various modifications, substitutions, additions, omissions, and the like can be made within the scope of the claims or the equivalents thereto.

The concept of the present disclosure can be applied to an electronic device (imaging apparatuses such as digital cameras, camcorders, mobile phones, smartphones, and the like) having an image shooting function provided with an image stabilizing function.

1. An imaging apparatus comprising:
an image sensor that captures a subject image via an optical system;
an image stabilizer that performs image stabilization responding to shake of the imaging apparatus;
a display that displays an image captured by the image sensor;
a user interface that receives a user operation; and
a controller that controls the image stabilizer, based on the user operation in the user interface,
wherein the controller causes the display to display a setting screen for setting stabilization power indicating a degree to perform the image stabilization, and
receives the user operation on the setting screen in the user interface, to set the stabilization power in accordance with the user operation.

2. The imaging apparatus according to claim 1, wherein
the controller has a first operation mode activated before the stabilization power is set on the setting screen, and
in the first operation mode,
the image stabilizer performs the image stabilization with moderating in accordance with a trial stabilization power that is under adjustment on the setting screen, and
the display displays the image captured by the image sensor with the image stabilization performed in accordance with the trial stabilization power.

3. The imaging apparatus according to claim 2, wherein
the controller
causes the display to transition from the setting screen to a display screen for the first operation mode in accordance with a first user operation on the setting screen, and
returns the display from the display screen for the first operation mode to the setting screen in accordance with a second user operation on the display screen for the first operation mode.

4. The imaging apparatus according to claim 2, wherein
the controller has a second operation mode different from the first operation mode, and
in the second operation mode after the stabilization power is set,
the image stabilizer performs the image stabilization with moderating in accordance with the set stabilization power, and
the display displays the image captured by the image sensor with the image stabilization performed in accordance with the set stabilization power.

5. The imaging apparatus according to claim 1, wherein
the setting screen includes a plurality of adjusters that respectively adjust a plurality of types of stabilization powers different from each other, and
the controller receives user operations on the plurality of adjusters in the setting screen, to set the respective types of stabilization powers adjusted in the respective adjusters.

6. The imaging apparatus according to claim 5, wherein the plurality of types of stabilization powers include a degree of the image stabilization in at least one of a yaw direction, a pitch direction, or a roll direction in the imaging apparatus.

7. The imaging apparatus according to claim 5, wherein the plurality of types of stabilization powers include a degree of the image stabilization in at least one of a horizontal translation direction or a vertical translation direction in the imaging apparatus.

8. The imaging apparatus according to claim 5, wherein the controller disallows a specific user operation on a specific adjuster among the plurality of adjusters, in accordance with a predetermined setting state for a pose of the imaging apparatus.

9. The imaging apparatus according to claim 5, wherein, when a type of stabilization power corresponding to one of the plurality of adjusters is adjusted to a predetermined value, the controller performs a setting to stop the image stabilization of the type.

10. The imaging apparatus according to claim 1, further comprising a communication interface mountable of an interchangeable lens to communicate data with the interchangeable lens mounted thereon, the interchangeable lens including the optical system,
wherein the controller sets the stabilization power in at least one of the imaging apparatus or the interchangeable lens, based on the data received from the interchangeable lens via the communication interface.

11. The imaging apparatus according to claim 10, wherein
the image stabilizer is a first image stabilizer,
the interchangeable lens includes a second image stabilizer that performs image stabilization by shifting a correction lens included in the optical system, and
the controller sets the stabilization power to the imaging apparatus and the interchangeable lens, to moderate dual image stabilization by the stabilization power, the dual image stabilization being simultaneously performed by the first image stabilizer and the second image stabilizer.

12. The imaging apparatus according to claim 10, wherein
the image stabilizer is a first image stabilizer,
the interchangeable lens includes a second image stabilizer that performs image stabilization by shifting a correction lens included in the optical system, and
the controller sets the stabilization power to the imaging apparatus and the interchangeable lens, to switch operation between the first image stabilizer and the second image stabilizer in accordance with a focal length of the interchangeable lens.

13. The imaging apparatus according to claim 10, wherein the controller sets the stabilization power to the imaging apparatus, when determining that the stabilization power is not settable to the interchangeable lens, based on the data received from the interchangeable lens via the communication interface.

14. The imaging apparatus according to claim 10, further comprising a memory that stores management information to manage a setting value for the stabilization power and the interchangeable lens in association with each other.

15. The imaging apparatus according to claim 1, wherein the controller causes the display to display identification information indicating whether the stabilization power is set with the image stabilization performed by the image stabilizer.

16. The imaging apparatus according to claim 1, wherein
the optical system includes a zoom lens that changes a focal length, and
the controller receives, on the setting screen, the user operation adjusting the stabilization power in accordance with the focal length of the optical system, to set the stabilization power.

17. The imaging apparatus according to claim 1, further comprising:
a communication interface that communicates data with a gimbal device mounted on the imaging apparatus; and
a memory that stores management information to manage a setting value for the stabilization power and the gimbal device in association with each other.
